(19) United States
(12) Patent Application Publication
(10) Pub. No.: US 2024/0253243 A1
(43) Pub. Date: Aug. 1, 2024

(54) SYSTEMS, DEVICES, AND METHODS FOR OPERATING A ROBOTIC SYSTEM

(71) Applicant: Sanctuary Cognitive Systems Corporation, Vancouver (CA)

(72) Inventor: Suzanne Gildert, Vancouver (CA)

(21) Appl. No.: 18/425,547

(22) Filed: Jan. 29, 2024

Related U.S. Application Data
(60) Provisional application No. 63/441,897, filed on Jan. 30, 2023.
(60) Provisional application No. 63/531,634, filed on Aug. 9, 2023.

(51) Int. Cl. B25J 13/00

(52) U.S. Cl. CPC B25J 13/003

(57) ABSTRACT

A robotic system includes a robot, and an interface to a large language model (LLM). The robot operates in an environment that includes a human. In an example method of operation of the robotic system, the robot initiates a task. After initiating the task, the robot detects that the human is waiting for the robot to complete the task. The interface sends a query to the LLM. The query includes a natural language statement describing a context in the natural language for the query. The interface receives a response from the LLM in reply to the query. The response includes a natural language statement describing material related to the context and suitable for an interim interaction that can be initiated by the robot with the human. The robot initiates the interim interaction with the human. The interim interaction may be initiated autonomously by the robot, and may include a diversion.

### TECHNICAL FIELD

The present systems, devices, and methods generally relate to the operation of a robotic system, and, in particular, the interaction of an autonomous or semi-autonomous robot with a human.

### BACKGROUND

Robots are machines that can assist humans or substitute for humans. Robots can be used in diverse applications including construction, manufacturing, monitoring, exploration, learning, and entertainment. Robots can be used in dangerous or uninhabitable environments, for example.

Machine learning and artificial intelligence techniques can be applied to the operation of a robotic system, for example, to help perform complex tasks based on real-time feedback.

A large language model (LLM) is an artificial intelligence (AI) system that has been trained on massive amounts of text data. Typically, an LLM can understand and generate human-like text, making it capable of various natural language-related tasks such as understanding context, answering questions, generating responses, and writing coherent paragraphs.

An LLM can be trained using deep-learning techniques on vast datasets that include diverse sources such as books, articles, websites, and other written content. During training, the LLM can learn patterns, grammar, and semantic relationships from the text data, allowing it to generate coherent and contextually relevant responses.

An LLM can be used in a wide range of applications, for example, natural language understanding, content generation, language translation, language learning, text summarization, creative writing, virtual simulation, and gaming.

LLM technology has immense potential to transform how humans and other systems interact with AI systems, provide language-related services, and enhance various aspects of human-machine interaction.

### BRIEF SUMMARY

A method of operation of a robotic system, the robotic system comprising a robot and an interface to a large language model (LLM), may be summarized as comprising operating, by the robotic system, the robot in an environment, the environment comprising a human, initiating, by the robot, a task, after the initiating of the task, detecting, by the robot, the human is waiting for the robot to complete the task, in response to detecting the human is waiting for the robot to complete the task, sending, by the interface, a query to the LLM, receiving, by the interface, a response from the LLM, the response in reply to the query, and initiating, by the robot, an interim interaction with the human, wherein the interim interaction is based at least in part on the response from the LLM.

In some implementations, the operating, by the robotic system, the robot in an environment includes operating a humanoid robot in the environment.

In some implementations, the initiating, by the robot, a task includes initiating at least one of an action, a generation of an action plan, a motion, a generation of a motion plan, a simulation, a calculation, a loading of a capability, a reception and/or a response to instructions, and an identification of an object in the environment.

In some implementations, the detecting, by the robot, the human is waiting for the robot to complete the task includes detecting autonomously, by the robot, the human is waiting for the robot to complete the task.

In some implementations, the detecting, by the robot, the human is waiting for the robot to complete the task includes detecting a timer has expired.

In some implementations, the detecting, by the robot, the human is waiting for the robot to complete the task includes detecting a duration of the task exceeds an expected duration. The detecting a duration of the task exceeds an expected duration may include determining an expected duration based at least in part on historical data.

In some implementations, the detecting, by the robot, the human is waiting for the robot to complete the task includes detecting a sign of impatience from the human. The robot may comprise a visual sensor, and the detecting a sign of impatience from the human may include detecting a sign of impatience from the human based at least in part on data from the visual sensor. The detecting a sign of impatience from the human based at least in part on data from the visual sensor may include scanning the environment, by the visual sensors, to generate sensor data, and analyzing, by the sensor data processor, the sensor data to detect a sign of impatience from the human based at least in part on the sensor data. The robot may comprise a sound sensor, and the detecting a sign of impatience from the human may include detecting a sign of impatience from the human based at least in part on data from the sound sensor.

In some implementations, the sending, by the interface, a query to the LLM includes sending a query to a chatbot.

In some implementations, the sending, by the interface, a query to the LLM includes sending a query to an LLM in the robotic system. The sending a query to an LLM in the robotic system may include sending a query to an LLM onboard the robot.

In some implementations, the sending, by the interface, a query to the LLM includes formulating a natural language statement. The formulating a natural language statement may include describing a context in the natural language. The describing a context in the natural language may include describing, in the natural language, at least one of the robot, the environment, the human, and the task.

In some implementations, the receiving, by the interface, a response from the LLM includes receiving a natural language statement from the LLM, and parsing the natural language statement.

In some implementations, the initiating, by the robot, an interim interaction with the human includes initiating autonomously, by the robot, an interim interaction with the human.

In some implementations, the initiating, by the robot, an interim interaction with the human includes initiating, by the robot, a diversion.

In some implementations, the initiating, by the robot, an interim interaction with the human includes at least one of telling a joke, sharing a fact, posing a brainteaser, and initiating a conversation.

A computer program product for performing a method of operation of a robotic system, the robotic system comprising one or more non-volatile processor-readable storage media, one or more processors, a robot, and an interface to a large language model (LLM), the computer program product may be summarized as comprising data and processor-executable instructions stored in the one or more non-volatile processor-readable storage media that, when executed by the one or more processors communicatively coupled to the storage media, cause the one or more processors to perform the method of operation of the robotic system, the method comprising operating, by the robotic system, the robot in an environment, the environment comprising a human, initiating, by the robot, a task, after the initiating of the task, detecting, by the robot, the human is waiting for the robot to complete the task, in response to detecting the human is waiting for the robot to complete the task, sending, by the interface, a query to the LLM, receiving, by the interface, a response from the LLM, the response in reply to the query, and initiating, by the robot, an interim interaction with the human, wherein the interim interaction is based at least in part on the response from the LLM.

In some implementations, the operating, by the robotic system, the robot in an environment includes operating a humanoid robot in the environment.

In some implementations, the initiating, by the robot, a task includes initiating at least one of an action, a generation of an action plan, a motion, a generation of a motion plan, a simulation, a calculation, a loading of a capability, a reception and/or a response to instructions, and an identification of an object in the environment.

In some implementations, the detecting, by the robot, the human is waiting for the robot to complete the task includes detecting autonomously, by the robot, the human is waiting for the robot to complete the task.

In some implementations, the detecting, by the robot, the human is waiting for the robot to complete the task includes detecting a timer has expired.

In some implementations, the detecting, by the robot, the human is waiting for the robot to complete the task includes detecting a duration of the task exceeds an expected duration. The detecting a duration of the task exceeds an expected duration may include determining an expected duration based at least in part on historical data.

In some implementations, the detecting, by the robot, the human is waiting for the robot to complete the task includes detecting a sign of impatience from the human. The robot may comprise a visual sensor, and the detecting a sign of impatience from the human may include detecting a sign of impatience from the human based at least in part on data from the visual sensor. The detecting a sign of impatience from the human based at least in part on data from the visual sensor may include scanning the environment, by the visual sensors, to generate sensor data, and analyzing, by the sensor data processor, the sensor data to detect a sign of impatience from the human based at least in part on the sensor data. The robot may comprise a sound sensor, and the detecting a sign of impatience from the human may include detecting a sign of impatience from the human based at least in part on data from the sound sensor.

In some implementations, the sending, by the interface, a query to the LLM includes sending a query to a chatbot.

In some implementations, the sending, by the interface, a query to the LLM includes sending a query to an LLM in the robotic system. The sending a query to an LLM in the robotic system may include sending a query to an LLM onboard the robot.

In some implementations, the sending, by the interface, a query to the LLM includes formulating a natural language statement. The formulating a natural language statement may include describing a context in the natural language. The describing a context in the natural language may include describing, in the natural language, at least one of the robot, the environment, the human, and the task.

In some implementations, the receiving, by the interface, a response from the LLM includes receiving a natural language statement from the LLM, and parsing the natural language statement.

In some implementations, the initiating, by the robot, an interim interaction with the human includes initiating autonomously, by the robot, an interim interaction with the human.

In some implementations, the initiating, by the robot, an interim interaction with the human includes initiating, by the robot, a diversion.

In some implementations, the initiating, by the robot, an interim interaction with the human includes at least one of telling a joke, sharing a fact, posing a brainteaser, and initiating a conversation.

A robotic system may be summarized as comprising a robot, and an interface to a large language model (LLM) communicatively coupled to the object recognition system, wherein the object recognition subsystem comprises at least one processor and at least one non-transitory processor-readable storage medium communicatively coupled to the at least one processor, the at least one non-transitory processor-readable storage medium storing processor-executable instructions and/or data that, when executed by the at least one processor, cause the robotic system to perform a method for recognizing objects in the environment, the method which includes operating, by the robotic system, the robot in an environment, the environment comprising a human, initiating, by the robot, a task, after the initiating of the task, detecting, by the robot, the human is waiting for the robot to complete the task, in response to detecting the human is waiting for the robot to complete the task, sending, by the interface, a query to the LLM, receiving, by the interface, a response from the LLM, the response in reply to the query, and initiating, by the robot, an interim interaction with the human, wherein the interim interaction is based at least in part on the response from the LLM.

In some implementations, the robot includes a humanoid robot.

In some implementations, the initiating, by the robot, a task includes initiating at least one of an action, a generation of an action plan, a motion, a generation of a motion plan, a simulation, a calculation, a loading of a capability, a reception and/or a response to instructions, and an identification of an object in the environment.

In some implementations, the detecting, by the robot, the human is waiting for the robot to complete the task includes detecting autonomously, by the robot, the human is waiting for the robot to complete the task.

In some implementations, the detecting, by the robot, the human is waiting for the robot to complete the task includes detecting a timer has expired.

In some implementations, the detecting, by the robot, the human is waiting for the robot to complete the task includes detecting a duration of the task exceeds an expected duration. The detecting a duration of the task exceeds an expected duration may include determining an expected duration based at least in part on historical data.

In some implementations, the detecting, by the robot, the human is waiting for the robot to complete the task includes detecting a sign of impatience from the human. The robot may comprise a visual sensor, and the detecting a sign of impatience from the human may include detecting a sign of impatience from the human based at least in part on data from the visual sensor. The detecting a sign of impatience from the human based at least in part on data from the visual sensor may include scanning the environment, by the visual sensors, to generate sensor data, and analyzing, by the sensor data processor, the sensor data to detect a sign of impatience from the human based at least in part on the sensor data. The robot may comprise a sound sensor, and the detecting a sign of impatience from the human includes detecting a sign of impatience from the human based at least in part on data from the sound sensor.

In some implementations, the sending, by the interface, a query to the LLM includes sending a query to a chatbot.

In some implementations, the sending, by the interface, a query to the LLM includes sending a query to an LLM in the robotic system. The sending a query to an LLM in the robotic system may include sending a query to an LLM onboard the robot.

In some implementations, the sending, by the interface, a query to the LLM includes formulating a natural language statement. The formulating a natural language statement may include describing a context in a natural language. The describing a context in a natural language may include describing, in a natural language, at least one of the robot, the environment, the human, and the task.

In some implementations, the receiving, by the interface, a response from the LLM includes receiving a natural language statement from the LLM, and parsing the natural language statement.

In some implementations, the initiating, by the robot, an interim interaction with the human includes initiating autonomously, by the robot, an interim interaction with the human.

In some implementations, the initiating, by the robot, an interim interaction with the human includes initiating, by the robot, a diversion.

In some implementations, the initiating, by the robot, an interim interaction with the human includes at least one of telling a joke, sharing a fact, posing a brainteaser, and initiating a conversation.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a context diagram of an example implementation of a robotic system, in accordance with the present systems, devices, and methods.

FIG. 2 is a high-level block diagram of an example implementation of the robotic system of FIG. 1, in accordance with the present systems, devices, and methods.

FIG. 3 is a more detailed block diagram of the robotic system of FIG. 2, in accordance with the present systems, devices, and methods.

FIG. 4 is a block diagram of an example implementation of a controller of a robotic system (e.g., the robotic system of FIG. 2), in accordance with the present systems, devices, and methods.

FIG. 5 is a schematic drawing of a front view of a robot, in accordance with the present systems, devices, and methods.

FIG. 6 is a flow chart of an example implementation of a method of operation of a robotic system, in accordance with the present systems, devices, and methods.

FIG. 7 is a schematic drawing of an example environment of a robot (for example, the robot of FIG. 2), in accordance with the present systems, devices, and methods.

### DETAILED DESCRIPTION

The following description sets forth specific details in order to illustrate and provide an understanding of various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

The technology described herein includes the use of Large Language Models (LLMs) with robotic systems. For example, an LLM can be used to enhance the performance of a robotic system.

The robotic system may have an interface to one or more LLMs. The interface may include a direct interface to an LLM and/or an indirect interface to an LLM. The interface to the LLM may access the LLM indirectly via a computer program, for example, a software application, a bot, an agent, and/or a tool. An example of a software application that uses an LLM is ChatGBT which is an artificial intelligence chatbot.

Sending a query to an LLM by the interface may include sending a query directly to the LLM and/or sending a query indirectly to the LLM via a computer program, for example, a software application, a bot, an agent, and/or a tool. Similarly, receiving a response from an LLM by the interface may include receiving a response directly from the LLM and/or receiving a response indirectly from the LLM via a computer program, for example, a software application, a bot, an agent, and/or a tool.

In some implementations, the LLM is external to the robotic system. In some implementations, the LLM is an element of the robotic system. In some implementations, the LLM is onboard the robot.

In accordance with the present systems, devices, and methods, LLMs can, for example, help a robot to respond when the robot identifies there is a human in the robot's environment, and the human is waiting for an action by the robot. In some implementations, the robot autonomously identifies there is a human in the robot's environment, and the human is waiting for an action by the robot. The action for which the human is waiting may include a) an initiating of an interaction between the robot and the human, b) an initiating of a communication with the human, and/or c) a completion of a task by the robot.

In some implementations, the robot identifies one or more signs of impatience from the human. Detecting the one or more signs of impatience from the human may include collecting and analyzing sensor data from one or more sensors of the robotic system. The sensors may be onboard the robot.

In some implementations, the robot detects the human is becoming impatient. I some implementations, the human indicates verbally the human is becoming impatient. In some implementations, the robot anticipates the human will become impatient in the near future (e.g., if the task is taking longer than expected).

Identifying the human is waiting for an action by the robot may include identifying an unnatural and/or unexpected pause in an interaction between the robot and the human. In some cases, the pause may include an awkward silence.

In some implementations, the human is waiting for the robot because the human is waiting for the robot to complete a task. The task may have been initiated by the human. The task may have been initiated by the robot. The task may have been initiated autonomously by the robot. For example, and without limitation, the task may include at least one of the following: an action, a generation of an action plan, a motion, a generation of a motion plan, a simulation, a calculation, a loading of a capability, a reception and/or a response to instructions, and an identification of an object in the environment.

When the robot identifies the human is waiting for an action, the robot can send a query to an LLM. The query may include a natural language statement. The natural language statement may include a prompt for the LLM. The natural language statement may include a context. For example, the query may include a description of the robot, the environment, the human, and/or the action. The query may ask the LLM for something to say and/or do to fill the pause. For example, the LLM may suggest telling a joke, sharing a fact, posing a brainteaser, and/or initiating a conversation (e.g., small talk). Engaging the human may include a verbal exchange. Engaging the human may include engaging the human with a signal and/or a gesture, for example, a high-five, a hand-shake, and/or a thumbs-up.

In the present application, the interaction initiated by the robot with the human, while waiting for the robot to complete the task, is referred to as an interim interaction. The interim interaction may include a diversion. In the present application, the term “diversion” refers to an interim interaction that does not contribute to the completing of the task. The interim interaction may include engaging the human in conversation and/or in an activity. The engagement may be informative, entertaining, and/or amusing.

While the robot interacts with the LLM and the human, the robot can continue to work on completing the task in parallel. When the task is complete, the robot may continue to engage the human in the interim interaction. The robot may complete the interim interaction before indicating or responding to the completion of the task. In some implementations, completion of the task causes an interruption to the interim interaction.

Identifying the human is waiting for the robot may include setting a timer. Identifying the human is waiting for the robot may include detecting when the time for which the human has been waiting exceeds an expected duration. The expected duration may be determined by the robotic system, for example, by the robot. Identifying the human is waiting for the robot may include detecting that completion of the task is taking longer than expected, for example, based at least in part on historical data.

A robot may have one or more sensors that it can use to explore and characterize its environment. The sensors may include optical cameras, infrared sensors, LIDAR (light detection and ranging) sensors, and the like. The sensors may include video and/or audio sensors. Identifying there is an unnatural and/or unexpected pause in the interaction between the human and the robot may include collecting and analyzing sensor data.

LLMs typically operate on natural language (NL) inputs, and produce NL outputs. Natural language is a language that has developed naturally in use (e.g., English), in contrast to an artificial language or computer code, for example.

The present technology includes sending a natural language statement to an LLM, for example, as a query, and receiving a natural language response from the LLM. The robotic system may include an interface to the LLM which can i) generate a natural language statement that includes a context, and ii) parse a natural language response from the LLM to provide input to the robot on how to respond to the unnatural and/or unexpected pause.

Submitting a query to the LLM can include formulating a natural language statement, for example, “I'm busy running a computer simulation for someone, and, while we wait for results from the simulation, do you know any good jokes I could tell them to keep them amused?” Receiving a response from the LLM in reply to the query may include parsing a natural language statement, for example, “Here's a joke to keep the person amused while you both wait for the results. Why did the computer go to the doctor? Because it had a virus!” The natural language statement that is sent as a query to the LLM can be structured so as to dictate the form of an output received from the LLM, for example, “I'm busy running a computer simulation for someone, and we're waiting for results from the simulation. List five interesting facts about computer simulation in order, starting with the most interesting. Delimit the facts in the list using semicolons.”

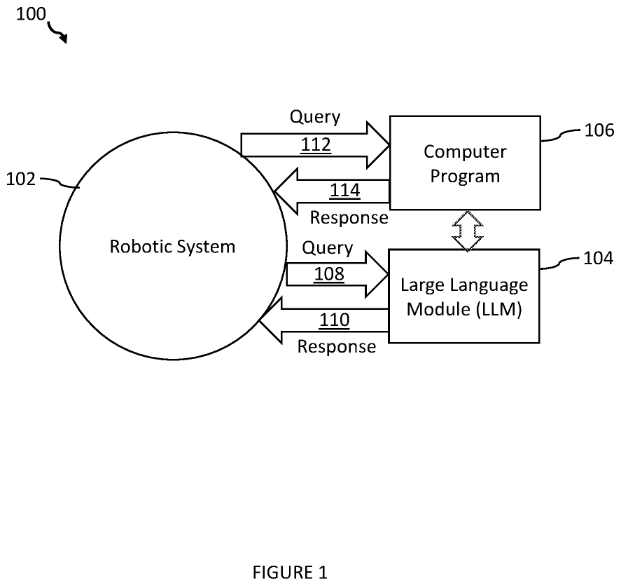

FIG. 1 is a context diagram 100 of an example implementation of a robotic system 102, in accordance with the present systems, devices, and methods. Context diagram 100 includes robotic system 102 and large language model (LLM) 104. As described above, LLM 104 may be accessed directly and/or indirectly via a computer program 106. For example, computer program 106 may be a software application, a bot, an agent, and/or a tool.

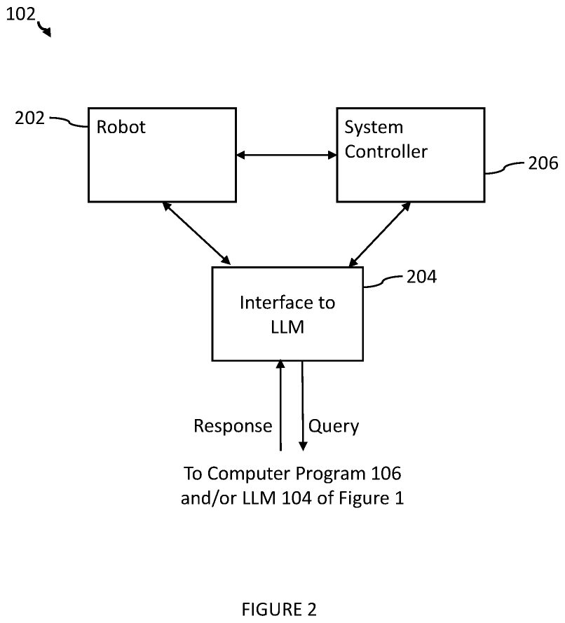

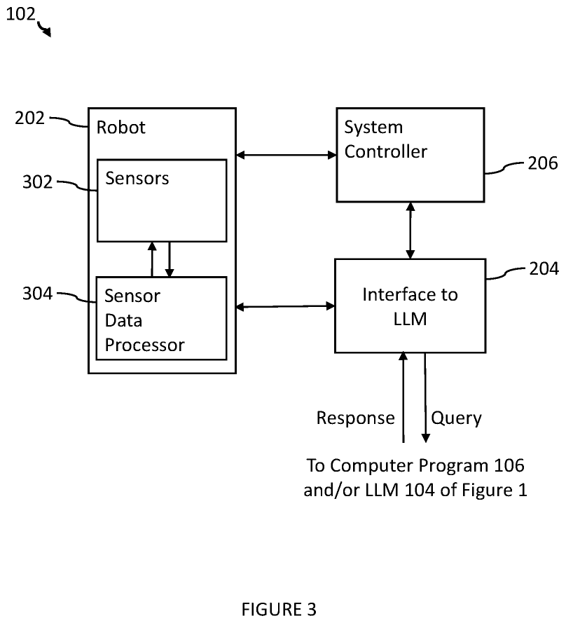

Robotic system 102 is described below with reference to FIGS. 2 and 3.

In the example robotic system illustrated in FIG. 1, LLM 104 is external to robotic system 102. In other example implementations, LLM 104 is part of robotic system 102.

Robotic system 102 is communicably coupled to LLM 104. In operation, robotic system 102 can send a query 108 to LLM 104. In operation, LLM 104 can send a response 110 to robotic system 102. Response 110 can be in reply to query 108. Query 108 sent by robotic system 102 to LLM 104 can be sent directly to LLM 104. Response 110 received by robotic system 102 from LLM 104 can be received directly from LLM 104.

In the example robotic system illustrated in FIG. 1, computer program 106 is external to robotic system 102. In other example implementations, computer program 106 is part of robotic system 102.

Robotic system 102 is communicably coupled to computer program 106. In operation, robotic system 102 can send a query 112 to computer program 106. In operation, computer program 106 can send a response 114 to robotic system 102. Response 114 can be in reply to query 112. Query 112 sent by robotic system 102 to LLM 104 can be sent indirectly to LLM 104 via computer program 106. Response 114 received by robotic system 102 from LLM 104 can be received indirectly from LLM 104 via computer program 106.

Query 112 can be a request for material a robot in robotic system 102 can use to fill an unnatural or unexpected pause (e.g., an awkward silence) in the robot's interaction with a human, for example, while the robot is busy completing a task. Response 114 can include material requested in query 112, for example, a joke, some interesting facts, a brainteaser, or ideas for a conversation.

Examples of topics that might be included in response 114 include, without limitation, current events, hobbies and interests, books, movies, and TV shows, travel experiences, personal development, technology and innovation, and science and discoveries. Response 114 may include one or more observations about the robot and/or the environment, for example, a comment on the weather.

FIG. 2 is a high-level block diagram of an example implementation of robotic system 102 of FIG. 1, in accordance with the present systems, devices, and methods.

Robotic system 102 includes a robot 202, an interface 204 to an LLM (for example, LLM 104 of FIG. 1), and a system controller 206. In some implementations, robot 202 includes a humanoid robot. A humanoid robot is a robot having an appearance and/or a character resembling that of a human.

System controller 206 is communicatively coupled to robot 202 and interface 204. System controller 206 may operate robot 202, and/or may initiate a task to be performed by robot 202. System controller 206 may cause interface 204 to send a query to the LLM, and/or to receive a response from the LLM. System controller 206 may cause robot 202 to fill an unnatural or unexpected pause in an interaction between robot 202 and a human (not shown in FIG. 2).

FIG. 3 is a more detailed block diagram of robotic system 102 of FIG. 2, in accordance with the present systems, devices, and methods. Robot 202 comprises sensors 302 and a sensor data processor 304. Sensor data processor 304 is communicatively coupled to sensors 302.

Sensors 302 may be visual sensors, for example. Sensors 302 may provide sensor data to sensor data processor 304. Robotic system 102 may detect a sign of impatience from a human based at least in part on the sensor data.

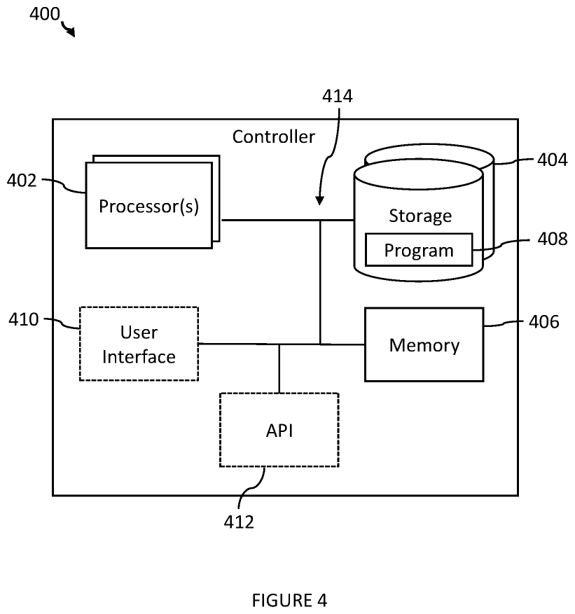

FIG. 4 is a block diagram of an example implementation of a controller of a robotic system (e.g., robotic system 102 of FIG. 1), in accordance with the present systems, devices, and methods. Controller 400 may be a system controller (e.g., system controller 206 of FIG. 2). Controller 400 may be a controller internal to robot 202 and/or interface 204. In various implementations, control functionality may be centralized or distributed.

Controller 400 includes one or more processors 402, one or more non-volatile storage media 404, and memory 406. The one or more non-volatile storage media 404 include a computer program product 408.

Controller 400 optionally includes a user interface 410 and/or an application programming interface (API) 412.

The one or more processors 402, non-volatile storage media 404, memory 406, user interface 410, and API 412 are communicatively coupled via a bus 414.

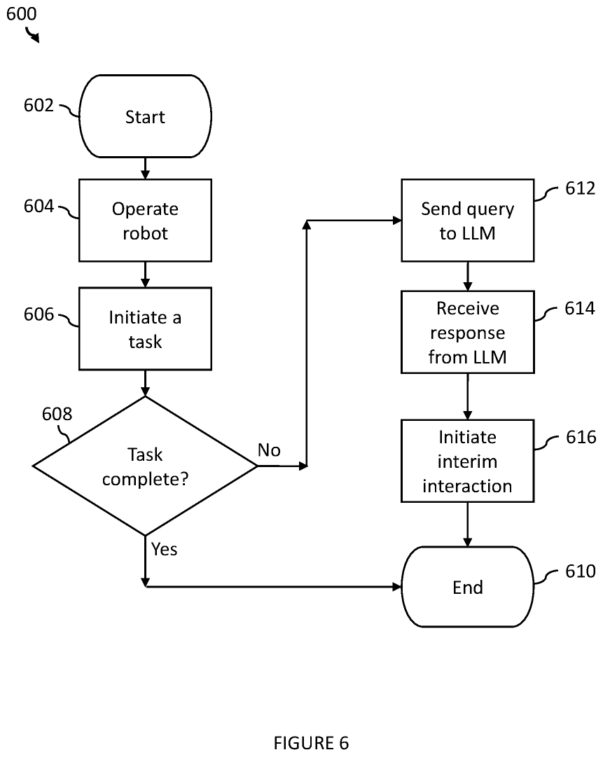

Controller 400 may control and/or perform some or all of the acts of FIG. 6 (described below with reference to FIG. 6).

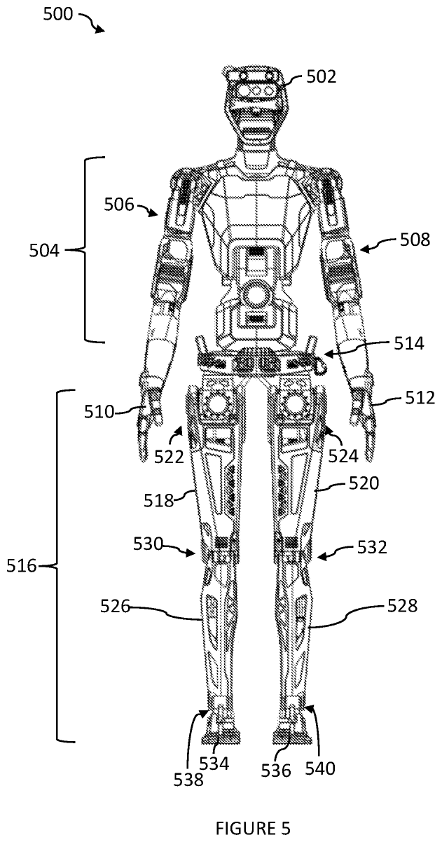

FIG. 5 is a schematic drawing of a front view of a robot 500 (for example, robot 202 of FIG. 2), in accordance with the present systems, devices, and methods. In some implementations, robot 500 is capable of autonomous travel (e.g., via bipedal walking).

Robot 500 includes a head 502, a torso 504, robotic arms 506 and 508, and hands 510 and 512. Robot 500 is a bipedal robot, and includes a joint 514 between torso 504 and robotic legs 516. Joint 514 may allow a rotation of torso 504 with respect to robotic legs 516. For example, joint 514 may allow torso 504 to bend forward.

Robotic legs 516 include upper legs 518 and 520 with hip joints 522 and 524, respectively. Robotic legs 516 also include lower legs 526 and 528, mechanically coupled to upper legs 518 and 520 by knee joints 530 and 532, respectively. Lower legs 526 and 528 are also mechanically coupled to feet 534 and 536 by ankle joints 538 and 540, respectively. In various implementations, one or more of hip joints 522 and 524, knee joints 530 and 532, and ankle joints 538 and 540 are actuatable joints.

Robot 500 may be a hydraulically-powered robot. In some implementations, robot 500 has alternative or additional power systems. In some implementations, torso 504 houses a hydraulic control system, for example. In some implementations, components of the hydraulic control system may alternatively be located outside the robot, e.g., on a wheeled unit that rolls with the robot as it moves around (see, for example, FIG. 2 and accompanying description below), or in a fixed station to which the robot is tethered. The hydraulic control system of robot 500 may include a hydraulic pump, a reservoir, and/or an accumulator. Hydraulic hoses may provide hydraulic couplings between the hydraulic control system and one or more pressure valves.

In some implementations, robot 500 may be part of a mobile robot system that includes a mobile base.

Robot 500 may include sensors, e.g., auditory, visual, tactile, and/or olfactory sensors. Robot 500 may include a speech generator and/or a sound generator. Robot 500 can use the speech generator and/or the sound generator in an interaction with a human (for example, the interim interaction initiated in act 616 of method 600 of FIG. 6 described below).

FIG. 6 is a flow chart of an example implementation of a method 600 of operation of a robotic system, in accordance with the present systems, devices, and methods. Method 600 of FIG. 6 includes eight (8) acts 602, 604, 606, 608, 610, 612, 614 and 616. Those of skill in the art will appreciate that in alternative implementations certain acts of FIG. 6 may be omitted and/or additional acts may be added. Those of skill in the art will also appreciate that the illustrated order of the acts is shown for exemplary purposes only and may change in alternative implementations.

At 602, in response to a starting condition, for example, identification of a human in an environment of a robot (for example, robot 202 of FIG. 2), method 600 starts. At 604, a controller (for example, system controller 206 of FIG. 2) operates the robot in the environment.

At 606, the robot initiates a task. The robot may be autonomous or semi-autonomous, and may initiate the task autonomously. The robot may be instructed to initiate a task, for example, by the controller.

If, at 608, the robot and/or the controller determines the task is complete, then control of method 600 proceeds to 610 where method 600 ends. Otherwise, control of method 600 proceeds to 612.

At 612, an interface to an LLM (e.g., interface 204 of FIG. 2) sends a query to the LLM (e.g., LLM 104 of FIG. 1). The query may include a natural language statement. The natural language statement in the query may include context, for example, a description of the robot, the human, the environment, and/or the task.

At 614, the interface to the LLM receives a response from the LLM, in reply to the query sent to the LLM at 612. The response may include a natural language statement. The natural language statement in the response may include material a) requested in the query, b) related to the context (if provided in the query), and/or c) suitable for use by the robot in an interim interaction the robot can initiate with the human. For example, if the query includes a request for a joke, then the response may include a joke.

At 616, the robot initiates an interim interaction with the human. The robot may initiate the interim interaction autonomously. The interim interaction may be a diversion. The interim interaction may include a telling of a joke, a sharing of a fact, a posing of a brainteaser, and/or an initiating of a conversation.

At 610, method 600 ends.

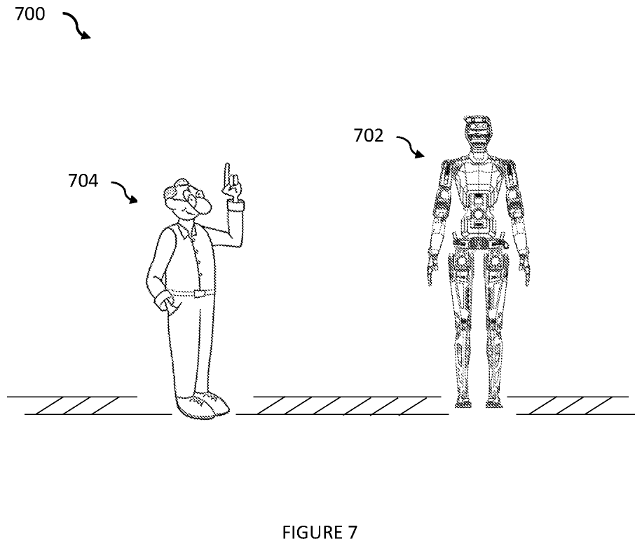

FIG. 7 is a schematic drawing of an example environment 700 of a robot 702 (for example, robot 202 of FIG. 2), in accordance with the present systems, devices, and methods. Environment 700 includes a human 704.

In an example implementation of a robotic system (for example, robotic system 102 of FIG. 1), robot 702 detects the presence of human 704. In response to identifying human 704 is impatient, or may become impatient, robot 702 queries an LLM (for example, LLM 104 of FIG. 1) and receives a response from the LLM that includes material suitable for the context and suitable for use in filling an unnatural or unexpected pause in the interaction between robot 702 and human 704.

In various implementations, environment 700 may include other objects (not shown in FIG. 7).

The various implementations described herein may include, or be combined with, any or all of the systems, devices, and methods described in U.S. Provisional Patent Application Ser. No. 63/441,897, filed Jan. 1, 2023; U.S. patent application Ser. No. 18/375,943, U.S. patent application Ser. No. 18/513,440, U.S. patent application Ser. No. 18/417,081, U.S. patent application Ser. No. 18/424,551, U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), US Patent Publication No. US 2021-0307170 A1, and/or U.S. patent application Ser. No. 17/386,877, as well as U.S. Provisional Patent Application Ser. No. 63/151,044, U.S. patent application Ser. No. 17/719,110, U.S. patent application Ser. No. 17/737,072, U.S. patent application Ser. No. 17/846,243, U.S. patent application Ser. No. 17/566,589, U.S. patent application Ser. No. 17/962,365, U.S. patent application Ser. No. 18/089,155, U.S. patent application Ser. No. 18/089,517, U.S. patent application Ser. No. 17/985,215, U.S. patent application Ser. No. 17/883,737, U.S. Provisional Patent Application Ser. No. 63/441,897, and/or U.S. patent application Ser. No. 18/117,205, each of which is incorporated herein by reference in its entirety.

Throughout this specification and the appended claims, infinitive verb forms are often used. Examples include, without limitation: “to provide,” “to control,” and the like. Unless the specific context requires otherwise, such infinitive verb forms are used in an open, inclusive sense, that is as “to, at least, provide,” “to, at least, control,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of robotic systems and hydraulic circuits provided.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A robotic system comprising:
a robot; and
an interface to a large language model (LLM) communicatively coupled to the object recognition system, wherein the object recognition subsystem comprises at least one processor and at least one non-transitory processor-readable storage medium communicatively coupled to the at least one processor, the at least one non-transitory processor-readable storage medium storing processor-executable instructions and/or data that, when executed by the at least one processor, cause the robotic system to perform a method for recognizing objects in the environment, the method which includes:
operating, by the robotic system, the robot in an environment, the environment comprising a human;
initiating, by the robot, a task;
after the initiating of the task, detecting, by the robot, the human is waiting for the robot to complete the task;
in response to detecting the human is waiting for the robot to complete the task, sending, by the interface, a query to the LLM;
receiving, by the interface, a response from the LLM, the response in reply to the query; and
initiating, by the robot, an interim interaction with the human, wherein the interim interaction is based at least in part on the response from the LLM.

2. The robotic system of claim 1, wherein the initiating, by the robot, a task includes initiating at least one of an action, a generation of an action plan, a motion, a generation of a motion plan, a simulation, a calculation, a loading of a capability, a reception and/or a response to instructions, and an identification of an object in the environment.

3. The robotic system of claim 1, wherein the detecting, by the robot, the human is waiting for the robot to complete the task includes detecting autonomously, by the robot, the human is waiting for the robot to complete the task.

4. The robotic system of claim 1, wherein the detecting, by the robot, the human is waiting for the robot to complete the task includes detecting a timer has expired.

5. The robotic system of claim 1, wherein the detecting, by the robot, the human is waiting for the robot to complete the task includes detecting a duration of the task exceeds an expected duration.

6. The robotic system of claim 5, wherein the detecting a duration of the task exceeds an expected duration includes determining an expected duration based at least in part on historical data.

7. The robotic system of claim 1, wherein the detecting, by the robot, the human is waiting for the robot to complete the task includes detecting a sign of impatience from the human.

8. The robotic system of claim 7, the robot comprising a visual sensor, wherein the detecting a sign of impatience from the human includes detecting a sign of impatience from the human based at least in part on data from the visual sensor.

9. The robotic system of claim 8, wherein the detecting a sign of impatience from the human based at least in part on data from the visual sensor includes:
scanning the environment, by the visual sensors, to generate sensor data; and
analyzing, by the sensor data processor, the sensor data to detect a sign of impatience from the human based at least in part on the sensor data.

10. The robotic system of claim 7, the robot comprising a sound sensor, wherein the detecting a sign of impatience from the human includes detecting a sign of impatience from the human based at least in part on data from the sound sensor.

11. The robotic system of claim 1, wherein the sending, by the interface, a query to the LLM includes sending a query to a chatbot.

12. The robotic system of claim 1, wherein the sending, by the interface, a query to the LLM includes sending a query to an LLM in the robotic system.

13. The robotic system of claim 12, wherein the sending a query to an LLM in the robotic system includes sending a query to an LLM onboard the robot.

14. The robotic system of claim 1, wherein the sending, by the interface, a query to the LLM includes formulating a natural language statement.

15. The robotic system of claim 14, wherein the formulating a natural language statement includes describing a context in the natural language.

16. The robotic system of claim 15, wherein the describing a context in the natural language includes describing, in the natural language, at least one of the robot, the environment, the human, and the task.

17. The robotic system of claim 1, wherein the receiving, by the interface, a response from the LLM includes receiving a natural language statement from the LLM, and parsing the natural language statement.

18. The robotic system of claim 1, wherein the initiating, by the robot, an interim interaction with the human includes initiating autonomously, by the robot, an interim interaction with the human.

19. The robotic system of claim 1, wherein the initiating, by the robot, an interim interaction with the human includes initiating, by the robot, a diversion.

20. The robotic system of claim 1, wherein the initiating, by the robot, an interim interaction with the human includes at least one of telling a joke, sharing a fact, posing a brainteaser, and initiating a conversation.
